(19) United States
(12) Patent Application Publication
(10) Pub. No.: US 2006/0107974 A1
(43) Pub. Date: May 25, 2006

(54) Soot cleaner

(76) Inventors: Thomas Klein, Koln (DE); Harry-Guenther Muller, Bergisch Gladbach (DE); Fred Ebert, Leverkusen (DE); Ralf Moritz, Neuss (DE)

Correspondence Address: LANXESS CORPORATION, 111 RIDC PARK WEST DRIVE, PITTSBURGH, PA, 15275-1112, US

(21) Appl. No.: 11/252,446

(22) Filed: Oct. 18, 2005

(30) Foreign Application Priority Data
Nov. 3, 2004 (DE) 10 2004 053 015.7

(51) Int. Cl. B08B 7/00

(52) U.S. Cl. 134/42

(57) ABSTRACT

The present invention relates to cleaning agents based on a water-soluble polymeric polycarboxylate as a dispersant for cleaning sooted surfaces.

The present invention relates to cleaning agents, preferably as powders, pastes or as an aqueous formulation, which are based on a water-soluble polymeric polycarboxylate as a dispersant for cleaning sooted surfaces.

Soot is a black powder which is 80-99.5% carbon and composed of very small, spherical particles which fuse together to form chainlike aggregates. The specific surface area is about 10-1000 m²/g. Soot is not to be confused with that other aciniform carbon known as carbon black, an important manufactured product formed in the complete combustion or pyrolysis of hydrocarbons. The furnace process is the most important manufacturing process. In the furnace process, hydrocarbon oils which are rich in aromatics and derived from coal tar or petroleum are injected into a gas flame at 1200-1800° C. Over 90% of the carbon black manufactured is used as a filler in the rubber industry, but carbon black is also used as a pigment for printing inks, writing inks, coatings and in the electrical industry. Soot is a usually undesired product of uncontrolled combustions and will then usually contain adsorbed oily constituents and pyrolysis products on its surface. Soot has demonstrated a carcinogenic potential in animal experiments, enhanced through the frequent presence of polycyclic aromatics.

Soot is also formed daily through combustion of motor fuels and preferentially of heating fuels, diesel motor fuels, gasolines, fats or the like.

These combustion processes of motor fuels and fats lead to an often firmly adhering greasy film on surfaces as occur in road transportation for example on tunnel linings, road signs, signalling systems, but also on heating systems, engines, in soot filters, on windscreens or on house exteriors and in the home.

It is known prior art to use water-soluble polymeric polycarboxylates, preferably polyaspartic acids, as cleaning agents.

EP-A 0 987 316 and EP-A 0 987 318 describe the use of polyaspartic acids in cleaner formulations having an abrasive action, the method of applying the cleaner formulations to the firm surface to be cleaned being akin to the sandblasting process in that they are applied in the course of a water jet cleaning operation.

EP-A 1 149 143 describes hard surface cleaner compositions comprising a combination of alkali-soluble polymeric compounds and nonionic surfactants, for machine cleaning of floors.

The cleaning of sooted surfaces, in particular when covered with a greasy film of soot and the polycyclic aromatics inevitably produced on burning motor fuels, has hitherto not been contemplated.

The present invention therefore has for its object to provide a cleaning agent for soot removal from surfaces. As used herein, surface refers to both firm and soft surfaces.

We have found that this object is achieved by the use of water-soluble polymeric polycarboxylates, preferably polyaspartic acid and/or salts thereof.

Preference for use as polyaspartic acids is given to polyaspartic acid homopolymers and their salts as described in WO 96/31 554. But it is also possible to use polyaspartic acids which are prepared by other processes of the prior art, for example EP-A 0 677 080. It is preferable to use the sodium salt and the ammonium salt of the polyaspartic acids, since they are biodegradable materials which are generally recognized as safe by ecologists. It is possible, of course, to use any other salt and water-soluble copolymer of the polyaspartic acids and their salts. It is similarly possible to use the anhydride of the polyaspartic acids, polysuccinimide (PSI).

The aforementioned polyaspartic acids and/or their derivatives are present, individually or mixed, in the soot cleaner in amounts of not less than 1% by weight and not more than 50% by weight.

The cleaning agents of the present invention may utilize the sodium salt of polyaspartic acid in amounts between 2% and 12% by weight.

In one preferred embodiment, the soot cleaners of the present invention further comprise at least one surfactant or emulsifier and/or at least one chelator.

Useful surfactants for the agents of the present invention include not only customary soaps but in particular synthetic surfactants from the classes of the anionic and nonionic surfactants. Examples of particularly suitable surfactants are sodium alkanesulphonates and ethoxylated fatty alcohols.

The aforementioned dispersing agents, chelators and surfactants are present, individually or mixed, in amounts of not less than 1% by weight. In all cases, the agents of the present invention comprise at least one water-soluble polymeric polycarboxylate, preferably polyaspartic acids, as characterizing constituent.

As well as surfactants, the agents of the present invention may comprise cosurfactants, alkalizers, alkaline complexers, water-miscible organic solvents, detersive salts, stabilizing agents as well as further customary additives.

Useful anionic cosurfactants include in particular C₈-C₂₂ alkanesulphonates, C₈-C₂₂ alkylbenzenesulphonates, C₈-C₂₂ alkyl sulphates, C₈-C₂₂ fatty acid ester sulphonates, C₈-C₂₂ fatty alcohol ether sulphates, fatty acid soaps or mixtures thereof. Anionic cosurfactants may be added in an amount up to 3% by weight and preferably in the range from 0.5% to 1% by weight based on the ready-produced agent.

Useful nonionic cosurfactants include for example the adducts of 13 to 40 mol of ethylene oxide with C₈-C₂₂ alcohols or of 1 to 40 mol of ethylene oxide with C₈-C₂₂ alkylphenols and alkylpolyglycosides. Nonionic cosurfactants may be used in an amount up to 8% by weight, in particular up to 6% by weight and more preferably up to 2% by weight based on the ready-produced soot cleaner.

The soot cleaners of the present invention may be embodied as so-called normal products, as concentrates and as pastes, in which case one of ordinary skill in the art will know that the boundaries between these products are not absolutely clear-cut.

Normal products are generally liquid and constitute solutions of their ingredients. The so-called concentrates are solutions or emulsions of the ingredients and have a liquid to viscous consistency. Typical surfactant contents are up to 35% by weight in normal products, up to 65% by weight in concentrates and up to 90% by weight in pastes. Pastes meterable via suitable appliances constitute the third possible embodiment. Pastes include the active ingredients in an amount up to 95% by weight. Additives and solvents are preferably omitted from pastes.

In one preferred embodiment, the soot cleaners comprise complexing agents which are capable of compensating performance impairment of the agent due to extreme water hardness. Suitable complexers are in particular pentasodium triphosphate, trisodium citrate, sodium gluconate, tetrasodium methylenediaminetetraacetate (EDTA-Na), pentasodium diethylenetriaminepentaacetate (DTPA-Na), tetrasodium 1,3-propylenediaminetetraacetate (1,3-PDTA-Na). Owing to their good biodegradability, products based on iminodisuccinic acid (IDSA), nitrilotriacetic acid (NTA) or beta-alaninediacetic acid (beta-ADA), methylglycinediacetic acid (MGDA), ethylenediaminedisuccinic acid (EDDSA) and 2-hydroxyethyleneiminodiacetic acid (HEIDA) are also used in the form of their free acids, as corresponding sodium salts or as ammonium salts. Preference is given to using IDSA, NTA-Na and/or sodium gluconate. Complexing agents may be utilized in an amount up to 15% by weight and preferably in the range from 0.5% to 12% by weight based on the ready-produced agent. When the agent comprises phosphates, the amount of complexing agents may be smaller.

To enhance cleaning power, water-miscible organic solvents may be included, in which case readily fat-soluble solvents are preferred. Examples of suitable solvents are mono- and dialcohols, ether alcohols and polyethers.

As typical representatives there may be mentioned isopropanol, butyl glycol, ethylene glycol monophenyl ether, dimethyldiglycol and methylpyrrolidone. Preference is given to using lower ether alcohols, for example mono- or diethylene monoalkyl ethers having 1 to 4 carbon atoms in the alkyl group. The organic solvent content is not above 30% by weight, preferably not above 20% by weight and in particular between 0.5% and 10% by weight based on the ready-produced agent.

As well as by the compounds mentioned as alkalizers, the performance of the soot cleaners of the present invention can be enhanced by addition of further alkaline salts, such as for example polyphosphates and pyrophosphates, in particular sodium tripolyphosphate or tetrapotassium pyrophosphate. But alkali metal hydroxides such as potassium hydroxide or sodium hydroxide can also be used. These salts are preferably used in an amount of 2% to 8% by weight, but not more than 15% by weight, based on the ready-produced agent.

To stabilize the individual components in the soot cleaners of the present invention, these may comprise solubilizers, such as for example cumenesulphonate, octyl sulphate, toluenesulphonate, xylenesulphonate or urea. These solubilizers may be present in the soot cleaners of the present invention in amounts up to 10% by weight, in particular in the range from 1% to 6% by weight, all based on the ready-produced soot-cleaning agent. Fatty acid soaps likewise have solubilizing properties. When the soot-cleaning agent comprises soap, the amount of solubilizer can therefore usually be very low.

As further optional constituents, the soot-cleaning agents of the present invention may also comprise inorganic neutral salts, dyes, scents, thickeners and corrosion inhibitors and also, if appropriate, disinfectants. The amount of additives is preferably not more than 5% by weight, preferably not more than 2% by weight and in particular in the range from 0.05% to 1% by weight, based on the ready-produced soot-cleaning agent. Further auxiliaries customary in cleaning agents for industrial purposes may likewise be present, provided they do not impair the effect according to the present invention.

In one possible embodiment of the present invention, the agent comprises 5% to 30% by weight of polyaspartic acid, 2% to 45% by weight of complexer, 0.1% to 10% by weight of further nonionic emulsifiers or surfactants, 0.1% to 10% by weight of anionic surfactants, 0.1% to 10% by weight of alkalizers, 0.1% up to 5% by weight of alkaline complexers, 0.1% to 30% by weight of water-miscible organic solvents and 0. 1% to 8% by weight of further additives, such as solubilizers, thickeners, dyes and scents.

Cleaning trials have shown the soot cleaners of the present invention to be also very effective on soils which, as well as soot, additionally comprised ash and occur for example in oil- or coal-burning boilers.

The present invention further relates to the use of the above-described soot cleaners for cleaning hard surfaces, in particular of tunnel linings, road signs, signalling systems, heating systems, engines, glass panes, car bodies, soot particulate filters or house exteriors.

The present invention further provides a process for machine cleaning of surfaces by cleaning the surfaces in a conventional manner with cleaning machines using the soot cleaners of the present invention.

It will be understood that the specification and examples are illustrative but not limitative of the present invention and that other embodiments within the spirit and the scope of the invention will suggest themselves to those skilled in the art.

### EXAMPLES

### Example 1

Cleaning contra soot on exteriors and tunnel linings

| | | |
|---|---|---|
| Baypure ®DS 100/40% (polyaspartic acid) | 30% | by weight |
| Baypure ®CX 100/34% (iminodisuccinic acid) | 3% | by weight |
| Emulgator L30 | 2% | by weight |
| Butylglycol | 1% | by weight |
| Water (deionized) | 64% | by weight |

### Example 2

Cleaning contra soot on engine block

| | | |
|---|---|---|
| Baypure ®DS 100/40 | 2.5% | by weight |
| Baypure ®CX 100/34% | 12% | by weight |
| Potassium hydroxide (50%) | 0.6% | by weight |
| Sodium metasilicate nonahydrate | 4.9% | by weight |
| Sulfetal 4105 (fatty alcohol sulphate) | 4.0% | by weight |
| Zusolat 1008/85 (alkylpolyethylene glycol ether) | 2.0% | by weight |
| Phosfetal 201 (phosphoric ester) | 2.0% | by weight |
| Butylglycol | 5.0% | by weight |
| Water (deionized) | 67.0% | by weight |

### Example 3

Glass cleaner for soot films on glass panes

| | | |
|---|---|---|
| Baypure ®CX 100 | 5% | by weight |
| Bayhibit ®AM | 3% | by weight |
| Tegotens ®B810 (Degussa AG, cationic surfactant) | 6.6% | by weight |
| Tegotens ®DO (Degussa AG, cationic surfactant) | 25% | by weight |
| Monoethanolamine | 3% | by weight |
| Water (deionized) | 57.4% | by weight |

### Example 4

Oil Boiler Cleaner for Use Contra Soot and Ash

| | | |
|---|---|---|
| Baypure ®DS 100/40% | 10% | by weight |
| Baypure ®CX 100/34% | 5% | by weight |
| Emulgator L 30 | 5% | by weight |
| Mersolat H 30 | 5% | by weight |
| Water (deionized) | 75% | by weight |

The cleaner formulations of the present invention surprisingly demonstrate excellent cleaning power on sooted surfaces. In contrast to the soils which are cleaned by means of water-soluble polymeric polycarboxylates in the prior art, soot has a neutral charge and combines with concomitant components to form greasy films. But it is especially against these where the soot cleaners of the present invention excel.

What is claimed is:

1. A method of use of water-soluble polymeric polycarboxylates for cleaning sooted surfaces.

2. A method of use according to claim 1, wherein polyaspartic acid is used as water-soluble polymeric polycarboxylate.

3. A method of use according to claim 1, wherein a complexing agent, preferably a product based on iminodisuccinic acid, is used in addition.

4. A method of use according to claim 1 , wherein an emulsifier or surfactant is used in addition.

5. A process for cleaning sooted surfaces, wherein water-soluble polymeric polycarboxylates are used.

6. A process according to claim 5, wherein the sooted surfaces are tunnel linings, road signs, signalling systems, heating systems, engines, soot particulate filters, glass panes, car bodies or house exteriors.

7. A soot cleaner comprising water-soluble polymeric polycarboxylates, preferably polyaspartic acids.

8. A soot cleaner according to claim 7, wherein additionally surfactants or emulsifiers and/or complexing agents are used.

9. A soot cleaner according to claim 8, wherein iminodisuccinic acid is used as complexing agent.

10. A method of use according to claim 1 wherein the sooted surfaces additionally comprise ash.
